(19) United States
(12) Patent Application Publication
(10) Pub. No.: US 2009/0071032 A1
(43) Pub. Date: Mar. 19, 2009

(54) DRYING PROGRAM WITH ANTI-CREASE PHASE AND DRYER

(75) Inventors: Uta Kreutzfeldt, Freystadt (DE); Hansjorg Lampe, Nurnberg (DE)

Correspondence Address: PEARNE & GORDON LLP, 1801 EAST 9TH STREET, SUITE 1200, CLEVELAND, OH, 44114-3108, US

(73) Assignee: Electrolux Home Products Corporation N.V., Zaventem (BE)

(21) Appl. No.: 12/299,219

(22) PCT Filed: Apr. 26, 2007
(86) PCT No.: PCT/EP07/03675

§ 371 Date: Oct. 31, 2008

(30) Foreign Application Priority Data
May 2, 2006 (EP) 06009014.9

(51) Int. Cl. F26B 7/00; F26B 3/02; F26B 19/00

(52) U.S. Cl. 34/389; 34/474; 34/425; 34/526

(57) ABSTRACT

The invention relates to a method of drying laundry in a dryer, in particular a tumble-dryer or a washing machine having dryer function, the method comprising: executing a drying program sequence; and thereafter executing a maintaining sequence, in particular an anti-crease sequence. According to the invention the maintaining sequence includes supplying (S) at least one additive to the laundry. Also a method is provided, wherein a drying program includes an anti-crease sub-sequence of supplying (S) at least temporarily steam in a jerkily or splashing manner to the laundry.

The present invention relates to a dryer having at least one drying program including an anti-crease phase (anti-wrinkle phase) following a main drying sequence or including a steam treatment phase during a drying sequence. The invention also relates to a dryer having an anti-crease function.

EP 1 441 060 A1 discloses a tumble dryer having one or two injection units arranged in proximity of the loading door of the dryer to inject an additive like water steam, a cleaning detergent, a fragrance or a disinfectant into the drum. It is proposed to reduce, stop or reverse the air flow through the drum to optimize the efficiency of the injected additive. For modifying the air flow, a fan is arranged in an air channel supplying drying air into the drum, wherein the fan is driven by a motor being separate from the driving motor of the drum and independently controlled by a control unit.

It is an object of the invention to provide a method for drying textiles and a dryer having an improved maintaining sequence (anti-crease phase) or improving the drying result.

The invention is defined in Claims 1, 23, 27 and 35, respectively.

Particular embodiments are set out in the dependent Claims.

According to Claim 1, a maintaining sequence is executed subsequent to a main drying program sequence. During the maintaining sequence the drying result achieved by executing and finishing the main drying program sequence is preserved, i.e. the maintaining sequence is adapted to restore the laundry as it is at the end of the main drying program. The maintaining sequence includes for example an anti-crease function or anti-wrinkle function (Knitterschutz) already known from prior art dryers. According to the invention, at least one additive is supplied to the laundry during the maintaining sequence. If, for example, the dryer is a tumble dryer of the exhaust type and a predetermined final humidity should be achieved with the main drying program (‘iron-aid’), then water can be supplied to the laundry during the maintaining sequence, such that an average humidity is maintained, even if the maintaining sequence lasts for a long period after having finished the main drying program. Thereby, the final humidity of the main drying program is independent of the storing time after the main program, even if some of the humidity is exhausted during ventilation and rotation phases in the maintaining sequence.

In a preferred embodiment water, in particular water steam, is at least temporarily supplied to the laundry during the maintaining sequence, such that the forming of wrinkles or creases is prevented very efficiently. Independent of the duration of the maintaining sequence, no additional wrinkles will form in the laundry as resulting from the main drying program or even wrinkles existing at the end of the main drying program are removed during the maintaining sequence.

In a further embodiment or additionally to the water, the supplied additive comprises or is for example a fragrance (or other additives) during the maintaining sequences such that the level thereof is kept at the final level at the end of the main drying program. For example, the additive to be replaced or compensated may decompose or volatilize during the storing time after the end of the main drying program. The adding of the at least one additive compensates this effect, so that again the storing time or delay until removal of the laundry from the dryer's compartment is replenished or compensated as if the laundry is immediately removed after the end of the main drying program.

It has been found that the supply of hot and droplet-free water steam in a jerkily or splashing (flushing) manner to the laundry best provides the anti-crease function and even removes wrinkles existing at the end of the main drying program.

According to a preferred embodiment, the supply of the at least one additive depends on one or more of the following parameters: the weight of the laundry, the type of textiles, an average temperature of the laundry, and an average value of humidity of the laundry. If, for example, the weight of the laundry stored in the compartment is low (e.g. only some shirts) the total amount of additive to be supplied to the laundry is correspondingly low. On the other hand, if for example heavy jeans are loaded into the drum, a correspondingly high amount of water has to be provided to the drum to maintain an average humidity during ventilation and exhausting the ventilated air. When delicate synthetics, silk or wool are stored in the compartment (type of textile), then the temperature of the additive supplied to the laundry is lowered to avoid damages to the textile structure.

Preferably, the additives are supplied in intervals and/or in a jerkily or splashing manner to the laundry, whereby the total amount of additive is more precisely controllable. At the same time the intermittent supply improves the anti-wrinkle effect.

Preferably, the laundry is agitated at least temporarily during the maintaining sequence, preferably during the supply phases, to achieve a circulation of the stored laundry and a homogeneous distribution of the supplied additives. Also a homogeneous temperature and humidity profile is achieved. For agitating the laundry a tumbling mode is used, which may include a reversal of the drum rotation. Additionally or alternatively, a ventilation of the laundry is made by introducing an airflow into the storing compartment of the dryer. The air may be circulated in a closed loop, in an exhaust way or in a mixture or switching between closed loop circulation and exhaust mode as for example suggested in prior art document EP 1 441 060 A1. Also during the maintaining sequence the airflow may be lowered as compared to the normal drying flow and may be reversed or stopped, e.g. by a blower arrangement as also known from EP 1 441 060 A1.

In a preferred embodiment the exhaust of humidity to the outside of the dryer or the condensation of humidity at a condenser of a condenser type dryer is controlled such that excess humidity exceeding a predefined level is removed from the storing compartment. Circulation or exhaust of the air from the storing compartment is also used to control for example the temperature and/or the humidity, if the corresponding detectors are arranged outside the storing compartment and detect the corresponding value in the circulated or exhausted drying air. Alternatively or additionally, the temperature is also controlled like the humidity by exhausting hot air or cooling it at the condenser. In a further preferred embodiment a drying sequence is executed when approaching the end of the maintaining sequence such that the humidity of the textiles in the drum is lowered, preferably to a predefined end humidity. This final drying sequence can for example be combined with or preceding a cooling sequence at the end of the maintaining sequence. Using this final drying sequence provides for example the advantage that the average humidity of the textiles during the maintaining sequence can be adjusted higher than the final humidity which is convenient to remove the textiles out of the drum for storing or further treatment. The higher humidity during most part of the maintaining sequence is then selected such that the anti-crease effect is optimized.

According to a preferred embodiment, the maintaining sequence is started after the end of the main drying cycle either automatically by the control of the dryer or manually by a user. For example, a remote device can be used by the user, which indicates by a corresponding status signal from the dryer to the remote control that the main drying program is finished. Then the user can either start the anti-crease sequence by pressing a corresponding start button at the remote control or can go to the dryer and press a button there to start the anti-crease program. Additionally or alternatively, the control of the dryer can detect that the laundry has not been removed within a predetermined time and can automatically start the maintaining program. The maintaining program may last a predefined time and end then. At the end of the first period of the maintaining program, the maintaining program can be started again either by the user or automatically as described for the first maintaining sequence. It may be provided that the maintaining sequence is repeated only for a predefined number of repetitions or is terminated after a predetermined total maintaining sequences time.

An automatic activation of the maintaining sequence may be for example provided by the control of the dryer, if the user has selected a corresponding program option, and/or the type of the preceding main drying program sequence indicates that the execution of a maintaining sequence is preferably started after ending the main drying program to preserve the drying result achieved with the main drying program.

According to Claim 23, an anti-crease or anti-wrinkle subsequence is performed during a main drying program sequence. During the anti-crease subsequence steam is at least temporarily introduced one or more times to the laundry stored in the compartment of the dryer. The short time supply of steam to the laundry assists in removing crinkles or creases remaining for example after spinning the laundry at the end of a washing program, e.g. of a washing machine. In particular, if the steam is provided in a flush, jerky or splashing manner, a steep temperature and humidity increase of the laundry is achieved, which has been observed to significantly reduce the wrinkles in the laundry.

Preferably, the steep increase in temperature of the laundry loaded with the steam is improved by setting a high temperature of the steam, reducing the humidity of the laundry prior to supplying the steam and/or cooling the laundry immediately before introducing the hot steam. When an exhaust dryer is used for example outside and cool air is introduced into the compartment immediately before supplying the steam, a higher temperature rise is achieved when introducing the steam from a supply unit. Also when the average humidity of the laundry has been reduced below to a predefined value, for example 10% or preferably to below 5% humidity, the heat capacity of the laundry is low and the heat introduced by the steam results in a high temperature rise.

Preferably, the laundry is mechanically agitated during the introduction of the steam, for example by operating a drum in a tumbling mode or in a reversing mode. Preferably, the air flow through the compartment of the dryer is reduced, stopped or reversed to assist the introduction of the steam to the laundry as for example described in EP 1 441 060 A1.

As regards further embodiments of the drying method according to Claim 23, reference is fully made to the above described embodiments either individually or completely for the drying method of Claim 1. In particular features as defined in one or more of Claims 2 to 22 are also applicable in combination with Claim 23.

According to Claims 27 and 35, a dryer is provided, which has a control unit adapted to control a drying program sequence according to any of the method Claims. Accordingly, the embodiments and advantages of the method Claims are also applicable to a dryer adapted in this way.

Reference is made in detail to preferred embodiments of the invention, examples of which are illustrated in the accompanying drawings which show:

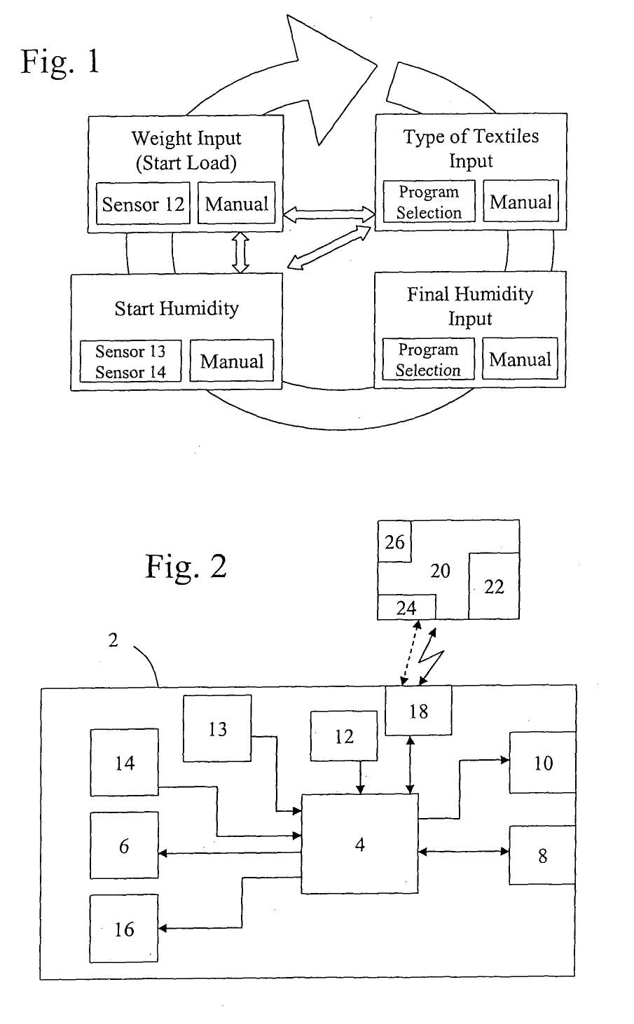

FIG. 1 a scheme of input program selections and program options,

FIG. 2 control elements of a dryer having a remote control, and

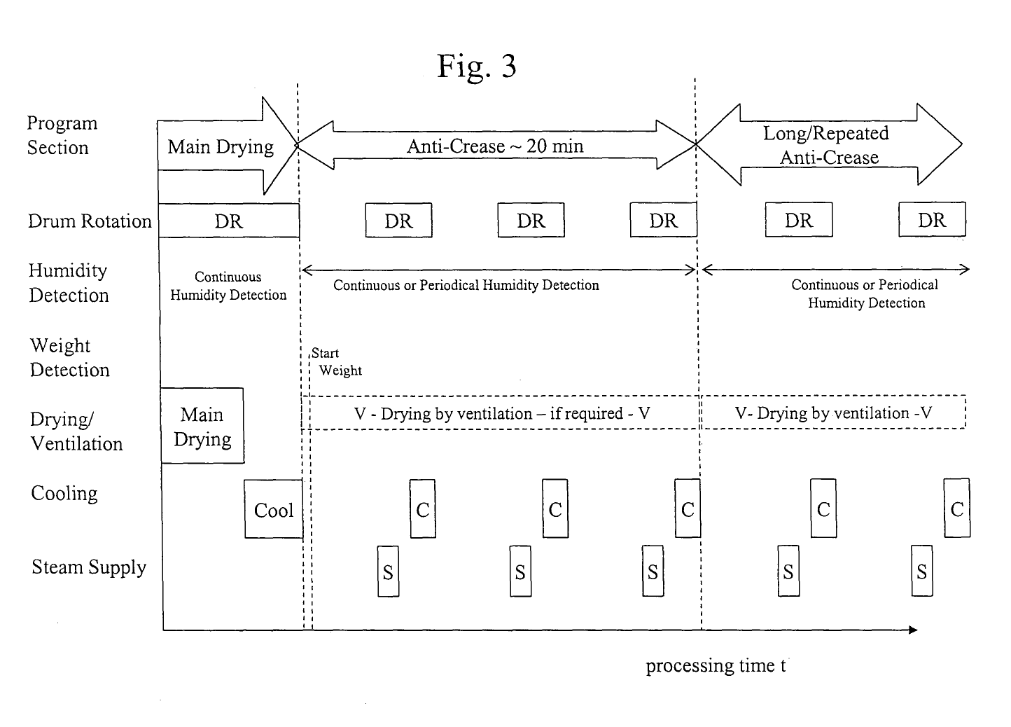

FIG. 3 a diagram depicting an exemplary anti-crease program cycle including sub-sequences of steam supply.

FIG. 1 schematically shows available programs and program options to be selected by the user. Mandatory selections (program selection) and optional selections (weight input, start humidity, final humidity input) are shown. For running the exemplary dryer 2 of FIG. 2 not all of the optional user selections or the input of all sensor detection results have to be implemented. In the following exemplary embodiment all input types shown in FIG. 1 are described—while keeping in mind that these have not to be implemented in any case or in any model of the dryer. User inputs are made prior to the start of the program cycle (for example the program selection), while detector inputs needed for an initial adaptation of the program are made in the starting phase. For example the start humidity is determined by a humidity sensor 14 of the dryer 2 when the drying process has already been started. Preferably the user selections and user inputs are made prior to starting the drying cycle.

The selection of an anti-crease program sequence following a main drying program sequence is made by the user before starting the main drying program or after the main drying program is finished. Preferably the user can generally activate or deactivate the anti-crease program by an option selection. Then —when the user has activated the anti-crease program—the dryer starts the anti-crease program in dependency of the type of main drying program. For example, if the main drying program has been selected to be cotton (jeans) or shoe drying program, an anti-crease program is not necessary. On the other hand, if the main drying program includes an anti-crease sub-sequence, it is valuable to preserve the anti-wrinkle result of the main drying program by automatically activating the anti-crease program by the dryer control.

As indicated in FIG. 1 an input of the type of textiles or laundry (cotton, synthetics, wool, silk etc.) is made either by a program selection or manually by the user. If for example the user selected program is specific for the type of textiles, no separate input for the type of textiles has to be made by the user. If the program is not destined for a specific type of textiles, a corresponding input can be optionally requested from the user. In another embodiment the type of textiles is derived for example by a mathematical or empirical model (look-up table, fuzzy-logic or neural network) from other input or detected inputs. For example the detected or user-input dry weight of the textiles combined with the ability of the textiles to soak water before reaching the final wetness is used to determine the type of textiles, i.e. the highest probability for one of the textile types.

The type of the textiles results in an adaptation of the drying program sequence in respect of the temperature during the drying or treatment sub-sequences and/or the type and amount of additives supplied to the laundry. Such input parameters (see also below) are not only used to adapt the main drying program, but also to adapt a subsequent maintaining program, like the anti-crease program.

In the same way the final humidity input for the final humidity of the laundry at the end of the drying cycle is either predetermined by a corresponding program selection or can optionally be input by the user. If, for example, a program is selected including “iron aid” or “pre-ironing” then the final humidity of the laundry is higher than in a program without such iron-specific determination. Optionally the user may manually select this for any of the drying programs. For example selection is made by pressing an option button “iron aid” assisting the subsequent ironing by a higher residual humidity of the laundry.

The weight of the laundry loaded into the compartment of the dryer 2 can either be automatically determined by a weight sensor 12 or is input by the user. For example the user input is a weight selection like “high”, “medium” and “low”. Or it may be a drum volume input like “full”, “half full” and “few pieces”. If such load input by volume is made, the type of textiles can be considered to derive the actual weight of the laundry (see arrow between inputs ‘weight’ and ‘type’ in FIG. 1). Also after inputting the weight and after detecting or manually inputting the start humidity, the dry weight of the textiles can be deduced by subtracting the expected water weight estimated on the basis of the humidity value (see arrow between inputs ‘start humidity’ and ‘type’ in FIG. 1). Of course also the type of textiles can be considered to calculate the dry weight which in turn is one of the factors to be included when determining an additive parameter like the amount of additive to be supplied to the laundry.

The starting humidity of the laundry is automatically determined by the humidity sensor 14 in a starting phase of the drying sequence or input by a user. If for example a refreshment program is selected, the laundry loaded into the dryer is normally dry and no pre-drying sequence is required. On the other hand, if hand washed or low-spun laundry (e.g. wool) is loaded and indicated by a corresponding program selection, the starting humidity is generally high.

FIG. 2 shows principal elements of the tumble dryer 2 in a block diagram. The tumble dryer 2 is an electronically controlled program dryer, the program being executed and controlled by a central processing unit 4. The user interface of the dryer comprises a display/indicator section 10 and an input panel 8. The input panel 8 has a program selector for selecting the main program, an input section to input for example the type of textile and the laundry weight. Options can be activated/deactivated by an option selector unit of the input panel to select for example the “iron aid”, the “anti-crease program” and so on.

The signals of a temperature sensor 13, the weight sensor 12 and the humidity sensor 14 are transmitted to the CPU for monitoring and controlling the drying process. Control signals are sent from the CPU 4 to a motor unit 6 driving independently a motor for the drum (not shown) and a ventilation fan. Also an additive injector 16 is controlled by CPU 4 to inject the additives as for example known from DE 103 02 864 A1 having a spraying device 31 and a stream generator 33 as described therein.

The display/indicator section 10 is arranged close to or combined with input panel 8 of the dryer. At the display/indicator section 10 specific status information can be observed by the user during inputting the selected program sequence and/or program option at the operator panel 8 and comprises a light indicator unit, a LCD display and a buzzer. The light indicator and/or buzzer informs the user for example about the end or the approaching end of the main drying program, if for starting the anti-crease program an active input from the user is required. Further, the indicator or a signal at the LCD display informs the user that the anti-crease program is running. In an embodiment the indication of the end or approaching end only starts, if the laundry has been cooled down (for example using a cooling sequence C shown at the end of the Main Drying, the Anti-Crease and the Long Anti-Crease sections) to a temperature where the laundry can be taken out of the drum.

The indication of the end or the approaching end of the main drying program can additionally or alternatively be indicated to the user by a remote control 20. The remote control comprises an indicator section 22, an I/O unit 28 and a remote input unit 26. The I/O unit 28 is in wire-based or wireless communication with an I/O unit 8 of the dryer 2. From the dryer 2 status information is transmitted to the I/O unit 28, which is transformed into corresponding indicator signals to be indicated at the indicator section 22. By the reverse transmission way input signals corresponding to an input of the user at the remote control 20 are transmitted from the remote control 20 to the dryer 2. The remote input unit 26 for transmitting input signals from the remote control 20 to the dryer 2 is optional and can be for example used to start the anti-crease program when the main drying program has been finished corresponding to an indication at the remote control 20. The indicator section 22 comprises a light indicator, a buzzer and a vibrator which are for example used in combination or in a time sequence to indicate the end or approaching end of the main drying program.

An exemplary user interaction with the user interface for the selection and options shown in FIG. 1 is now described: The display section 10 is a touch screen accepting user inputs by touching soft buttons displayed on the screen, which represent at least a portion of the input panel 8. As soon as the dryer is energized, the basic programs to be selected by the user are shown on the display and one of these basic programs is selected by the user. If a type of textiles is not determined by the basic selection, different types of textiles for selection are displayed. Thereafter a selection for the loaded volume as described above is shown—thereby implementing an implicit weight selection. When the weight or load selection has been made, a start button is displayed at the same time with additional options like the option button for activating the anti-crease program as mentioned above. These additional options can be activated by the user or can be skipped by starting the drying cycle with the start button.

Due to the main program selection, option selection, weight input, the textile type input and the detected starting humidity, the CPU 4 adapts the flow of sub-sequences of the main drying program and of the anti-crease program, the duration of the sub-sequences (if not determined for example by a final parameter for the sub-sequence as the humidity), the temperature during the sub-sequence, as well as the type and amount of additive to be applied to the laundry (if necessary in the respective sub-sequence).

FIG. 3 shows a time diagram illustrating the end phase of the main drying program, the anti-crease program and a following long anti-crease program (indicated by the wide arrows in the first line). During the end phase of the main drying program the drum is permanently rotated in a tumbling mode and air is permanently blown through the drum to remove humidity from the laundry. During the main drying subsequence (“Main Drying”) the air is heated and in the cooling sequence (“Cool”) the laundry is cooled down for unloading by the user or for a prolonged storing during the anti-crease program.

At the beginning of the anti-crease program the start weight is detected by the weight sensor 12 to adapt the water amount supplied onto the laundry in dependency of the weight. Periodically the drum is rotated (“DR”) for a time period. Preferably with the same periodicity as the drum rotation but with a much shorter duration, steam (“S”) is intermittently flushed to the laundry. Following the steam treatment a cooling phase (“C”) is activated to cool the laundry to a predetermined average storing temperature. While the drum is rotated, the ventilation (“V”) is activated by flowing air through the drum in dependency of the other sub-sequences, the humidity detected by the humidity sensor 14 and/or the temperature detected by the temperature sensor 13:
Preferably the ventilation is stopped during the steam phase S to increase the temperature rise.
During the cooling phase C excessive heat is removed, for example by steam condensation in a condensation dryer.
If an excess temperature or humidity is detected throughout the anti-crease program, heat and humidity are removed by exhausting air from the drum to the outside or by flowing it to a heat exchanger or condenser.

Typically the time period of steam supply S is 20 sec to 5 min, preferably 2 min. Typically the time period prior to each steam phase S is 5 to 20 min, preferably 10 to 15 min. During the steam supply phases S the steam is supplied in a plurality of short pulses.

As soon as the anti-crease program is finished or when the end of the anti-crease program approaches, the user can be informed of the end as described above for the end or approaching end of the long anti-crease program. Accordingly, the long anti-crease program can be started manually or automatically. In the embodiment of FIG. 3 the long anti-crease program is identical to the anti-crease program. However, it may deviate from the structure of sub-sequences used in the anti-crease program.

During the anti-crease program and the long anti-crease program the supply of steam S to the laundry can be terminated and the programs can continue with the other sub-sequences (preferably without the cooling phase C) or a conventional anti-crease program can be started. Such a change from steam-assisted anti-crease to steam-less anti-crease may be initiated by the detection of running empty of the water in a water reservoir feeding the additive injector 16.

In an embodiment not shown the main drying program itself has an anti-crease boost phase in which steam is supplied to the laundry. This anti-crease boost phase of the main drying program may comprise one or more periods as described above for the repeating periods during the anti-crease program (in FIG. 3 three such repeating periods are shown for the anti-crease program and only two for the long anti-crease program).

### REFERENCE NUMERALS LIST

2 tumble dryer
4 CPU
6 motor unit
8 input panel
10 display/indicator section
12 weight sensor
13 temperature sensor
14 humidity sensor
16 additive injector
18 I/O unit
20 remote control
22 indicator section
24 I/O unit
26 remote input unit

1. Method of drying laundry in a dryer (2), in particular a tumble-dryer or a washing machine having dryer function, the method comprising:
executing a drying program sequence and thereafter
executing a maintaining sequence, in particular an anti-crease sequence, wherein the maintaining sequence includes supplying (5) at least one additive to the laundry.

2. Method of claim 1, wherein at least one of the following additives is supplied to the laundry during the maintaining sequence: pure water, a mixture comprising water, a dry detergent, a disinfectant, an impregnant and/or a softener.

3. Method of claim 2, wherein water or a mixture comprising more than 90% by weight water, preferably more than 95%, the only additive supplied to the laundry.

4. Method of claim 1, wherein the at least one is supplied as a fog or as steam to the laundry, in particular a droplet-free steam.

5. Method according to claim 4, wherein the steam temperature is above 90° C., preferably above 100° or 110°C.

6. Method according to claim 1, wherein the at least one additive is supplied (S) in intervals and/or in a flushing manner to the laundry.

7. Method according to any claim 1, wherein during the maintaining sequence at least the average humidity of the laundry is kept constant, preferably at predetermined value.

8. Method of claim 7, wherein the predetermined value of humidity is set in dependency of the preceding drying program sequence and/or of a user selection.

9. Method according to claim 1, wherein the amount, the flow rate and/or the temperature of the at least one additive is set in dependency of at least one of the following parameters: the weight of the laundry, the type of textiles, and the humidity set for the maintaining sequence.

10. Method according to claim 1, wherein the maintaining sequence includes at least one drying subsequence (V) and/or at least one cooling sub-sequence (C), in particular a drying sequence at the end of the maintaining sequence to dry the laundry to a predefined end humidity.

11. Method of claim 10, wherein the drying sub-sequence (V) is executed permanently or in intervals during the maintaining sequence, in particular in the period between intervals of supply (S) of the at least one additive to the laundry.

12. Method of claim 10, wherein the cooling sub-sequence (C) is executed permanently or in intervals during the maintaining sequence, in particular subsequent to a supply (S) of the at least one additive to the laundry.

13. Method of claim 9, wherein the temperature is cooled to below a predefined temperature, in particular to below 40° C. or 35° C.

14. Method according to claim 1, wherein during the maintaining sequence at least temporarily air is ventilated (V) through a storing compartment for the laundry.

15. Method according to claim 1, wherein during the maintaining sequence the air flow is reduced, reversed, stopped or waved.

16. Method of claim 14, wherein during the maintaining sequence the air from the compartment is at least partially and at least temporarily exhausted.

17. Method according to claim 1, wherein during the maintaining sequence an anti-crease sub-sequence (DR, V) and an additive-supply sub-sequence (5) are periodically repeated.

18. Method according to claim 1, wherein the maintaining sequence is manually or automatically started, extended or restarted.

19. Method of claim 18, wherein the user can manually start or extend the maintaining sequence.

20. Method according to claim 1, wherein the maintaining sequence is terminated or replaced by an anti-crease program (DR, V) when a predefined state of the dryer is detected, in particular the depletion of at least one of the additives.

21. Method according to claim 1, wherein the dryer (2) is adapted to execute a plurality of drying program sequences different to each other and wherein the maintaining sequence is executed following to at least one of the drying program sequences.

22. Method according to claim 1, wherein the activation of the execution of the maintaining sequence depends on a user selection to activate or deactivate the maintaining sequence.

23. Method of drying laundry in a dryer (2), in particular a tumble-dryer, a washing machine having dryer function or a method, the method comprising executing a drying program sequence comprising an anti-crease sub-sequence (DR, V), wherein the anti-crease sub-sequence includes supplying (S) at least temporarily steam to the laundry, in particular supplying the steam in a jerkily or splashing manner.

24. Method of claim 23, wherein the temperature of the laundry is reduced to below a predefined temperature and/or the humidity is reduced to a predefined humidity value.

25. Method of claim 23, wherein subsequent to the supply (S) of the steam the laundry is cooled (C).

26. Method of claim 23, wherein the average humidity, the average temperature of the laundry, the amount of the steam, the flow rate of the steam and/or the temperature of the steam is set in dependency of the weight of the laundry and/or the type of textiles.

27. Dryer, in particular tumble dryer (2) or washing machine providing a dryer function, comprising:
a control unit (4) adapted to control at least one main drying program sequence and at least one maintaining sequence subsequent to the main drying sequence;
a control panel (8) for selecting and/or starting the at least one main drying program sequence and/or a maintaining option by the user; and
a supply unit (16) adapted to supply (S) at least one additive to the laundry stored in a compartment of the dryer;
characterized in that
the control unit (4) is adapted to control the supply unit (16) to supply (S) at least one additive to the laundry during the maintaining sequence.

28. Dryer according to claim 27, wherein the control unit (4) controls supplying (S) at least one of the following additives by the supply unit (16) to the laundry: pure water, a mixture comprising water, a dry detergent, a disinfectant, and a softener.

29. Dryer according to claim 27, wherein the control unit (4) is adapted to control the supply (S) of at least one additive to the laundry during the maintaining sequence in intervals or in a flushing manner, in particular the supply of steam.

30. Dryer according to claim 27, wherein the control unit (4) is adapted to control a cooling phase (C) subsequent to the supply of steam and/or drying phase (V) prior to the supply (S) of steam.

31. Dryer according to claim 27, wherein the control unit (4) is adapted to drive a fan motor (6) adapted to vary the flow of air through the compartment of the dryer (2), in particular independent of a motor driving a drum of the dryer.

32. Dryer according to claim 27, comprising a sensor unit (12, 13, 14) wherein the sensor unit comprises a humidity sensor (14), a conductivity sensor, a weight sensor (12) and/or a temperature sensor (13).

33. Dryer according to claim 27, wherein the control panel (8) comprises at least one of the following: a program selector, a weight selector, and a final humidity selector.

34. (canceled)

35. Dryer, in particular tumble dryer (2), washing machine providing a dryer function or dryer according to claim 27, comprising:
a control unit (4) adapted to control at least one drying program sequence;
a control panel (8) for selecting and/or starting the at least one drying program sequence; and
a supply unit (16) adapted to supply steam to the laundry stored in a compartment of the dryer;
characterized in that
the control unit (4) is adapted to control the supply unit (16) to supply (5) steam to the laundry during an anti-crease sub-sequence of the drying program sequence, in particular to control the supply in a flushing manner.

36. (canceled)
